(19) United States
(12) Patent Application Publication
(10) Pub. No.: US 2026/0031887 A1
(43) Pub. Date: Jan. 29, 2026

(54) METHOD FOR BEAM FAILURE RECOVERY FOR L1/L2 CENTRIC INTER-CELL MOBILITY

(71) Applicant: Google LLC, Mountain View, CA (US)

(72) Inventor: Yushu Zhang, Beijing (CN)

(21) Appl. No.: 18/995,668

(22) PCT Filed: Aug. 5, 2022
(86) PCT No.: PCT/CN2022/110606

§ 371 Date: Jan. 16, 2025

(51) Int. Cl. H04B 7/06; H04B 17/318; H04L 5/00

(52) U.S. Cl. CPC H04B 7/06964; H04B 7/0626; H04B 7/06968; H04B 17/328; H04L 5/0053

(57) ABSTRACT

This disclosure provides systems. devices. apparatus. and methods, including computer programs encoded on storage media, for BFR techniques based on ICM. A UE (102) activates (420), based on a beam failure with a first network entity (304). a communication gap duration in which the UE (102) refrains from monitoring for signals from the first network entity (304) in at least one of a same CC. a first set of CCs of a same band. or a second set of CCs of a band combination associated with the first network entity (304). The UE (102) receives (422). during the communication gap duration. a CBD reference signal from the second network entity (404). A measurement (424) of the CBD reference signal is indicative of one or more candidate beams associated with the second network entity (404) for recovering from the beam failure with the first network entity (304).

### TECHNICAL FIELD

The present disclosure relates generally to wireless communication, and more particularly, to beam failure recovery (BFR) techniques based on inter-cell mobility (ICM).

### BACKGROUND

The Third Generation Partnership Project (3GPP) specifies a radio interface referred to as fifth generation (5G) new radio (NR) (5G NR). An architecture for a 5G NR wireless communication system can include a 5G core (5GC) network, a 5G radio access network (5G-RAN), a user equipment (UE), etc. The 5G NR architecture might provide increased data rates, decreased latency, and/or increased capacity over other types of wireless communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies that support communication with multiple UEs. As mobile broadband technologies evolve, improvements in mobile broadband have been useful to continue the progression of such technologies. For example, a user equipment (UE) may perform a beam failure recovery (BFR) procedure to recover from a beam failure event, which may be based on an abrupt change to a beam (e.g., control channel beam) that the UE is using to communicate with a base station or a network entity at the base station. While such BFR procedures are applicable to serving cells, inter-cell mobility (ICM) operations might provide an opportunity to extend BFR procedures to neighbor cells/target cells that are different from the serving cell.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

For a user equipment (UE) to declare that a beam failure event has occurred, a serving network entity may periodically transmit beam failure detection (BFD) reference signals to the UE, such that the UE may measure a block error rate (BLER) for each BFD reference signal. If the BLER exceeds a threshold for N consecutive measurement instances, the UE may declare the beam failure event and identify a different beam (e.g., candidate beam) to communicate with the serving network entity based on a serving candidate beam detection (CBD) reference signal received from the serving network entity. The serving CBD reference signal may indicate one or more first beams of the serving network entity. If any of the one or more first beams have a reference signal received power (RSRP) above an RSRP threshold, the UE may indicate to the serving network entity in a beam failure recovery request (BFRQ) during a random access channel (RACH) procedure the different beam/candidate beam that the UE has identified/selected for recovering from the beam failure event. The serving network entity may also transmit a response to the BFRQ in a beam failure recovery response (BFRR) message during the RACH procedure that indicates a network-selected beam to complete a beam failure recovery (BFR) procedure, where the network-selected beam might be a same beam as the different beam/candidate beam that the UE indicated in the BFRQ.

To support inter-cell mobility (ICM) for BFR procedures, a candidate network entity may transmit one or more CBD reference signals to the UE, where the one or more CBD reference signals indicates one or more second beams of the candidate network entity. The UE may update radio resource control (RRC) parameters for communicating based on the one or more second beams of the candidate network entity. However, an arrival time difference between the one or more first beams of the serving network entity and the one or more second beams of the candidate network entity might be greater than a cyclic prefix (CP) associated with the beams, such that the UE may be unable to measure both the CBD reference signal from the candidate network entity and other signals from the serving network entity in a same component carrier (CC) or in different CCs at a same time. That is, a delay duration between receiving the BFRR message from the serving network entity and updating the RRC parameters may be too short for the UE to receive the CBD reference signal from the candidate network entity.

In an aspect of the disclosure, a method, a computer-readable medium, and an apparatus are provided. A UE activates, based on a beam failure with a first network entity, a communication gap duration in which the UE refrains from monitoring for signals from the first network entity in at least one of a same CC, a first set of CCs of a same band, or a second set of CCs of a band combination associated with the first network entity. The UE receives, during the communication gap duration, a CBD reference signal from the second network entity. A measurement of the CBD reference signal is indicative of one or more candidate beams associated with the second network entity for recovering from the beam failure with the first network entity.

In another aspect of the disclosure, a method, a computer-readable medium, and an apparatus are provided. A first network entity providing a serving cell transmits, to a UE, a configuration for a communication gap duration. An activation of the communication gap duration is associated with a transmission time of a CBD reference signal from a second network entity and corresponds to a time when signals from the first network entity are unmonitored in at least one of a same CC, a first set of CCs of a same band, or a second set of CCs of a band combination associated with the first network entity. The first network entity communicates with the UE when the communication gap duration expires.

In another aspect of the disclosure, a method, a computer-readable medium, and an apparatus are provided. A second network entity providing a neighbor cell receives a backhaul communication from a first network entity indicative of a UE configuration for a communication gap duration that corresponds to a time when signals of the first network entity are unmonitored in at least one of a same CC, a first set of CCs of a same band, or a second set of CCs of a band combination associated with the first network entity. An activation of the communication gap duration is associated with a transmission time of a CBD reference signal from the second network entity. The second network entity transmits the CBD reference signal based on at least one of the configuration for the communication gap duration or the activation of the communication gap duration.

To the accomplishment of the foregoing and related ends, the one or more aspects include the features hereinafter described and particularly pointed out in the claims. The one or more aspects may be implemented through any of an apparatus, a method, a means for performing the method, and/or a non-transitory computer-readable medium. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 illustrates a diagram of a wireless communications system associated with a plurality of cells.

FIG. 2 illustrates a timing diagram of a transmission configuration indicator (TCI) update procedure based on TCI signaling between a user equipment (UE) and a base station or an entity at a base station.

FIG. 3 is a communication signaling diagram illustrating a beam failure recovery (BFR) procedure for a serving cell.

FIG. 4 is a communication signaling diagram illustrating a network-activated communication gap at the UE.

FIG. 5 is a communication signaling diagram illustrating a UE-activated communication gap at the UE.

FIG. 6 is a communication signaling diagram illustrating a BFR procedure between the UE and the first/second network entities.

FIGS. 7A-7B are flowcharts of a method of wireless communication at a UE.

FIG. 8 is a flowchart of a method of wireless communication at a first network entity.

FIG. 9 is a flowchart of a method of wireless communication at a second network entity.

FIG. 10 is a diagram illustrating an example of a hardware implementation for an example UE apparatus.

FIG. 11 is a diagram illustrating an example of a hardware implementation for an example network entity.

### DETAILED DESCRIPTION

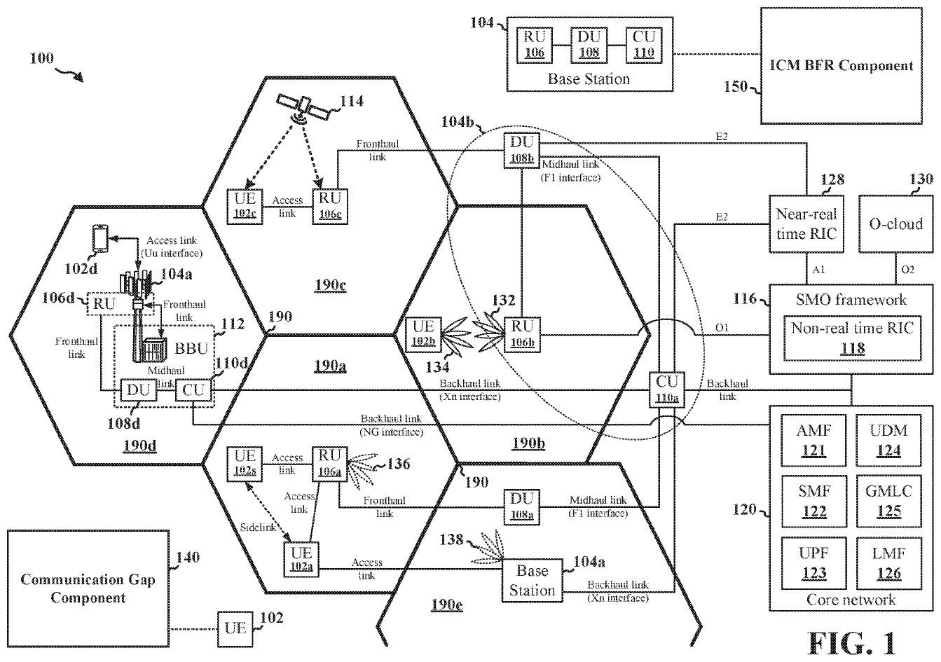

FIG. 1 illustrates a diagram 100 of a wireless communications system associated with a plurality of cells 190. The wireless communications system includes user equipments (UEs) 102 and base stations 104, where some base stations 104a include an aggregated base station architecture and other base stations 104b include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 may be implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU).

Operations of the base stations 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a may communicate with the DUs 108a-108b via respective midhaul links based on F1 interfaces. The DUs 108a-108b may respectively communicate with the RU 106a and the RUs 106b-106c via respective fronthaul links. The RUs 106a-106c may communicate with respective UEs 102a-102c and 102s via one or more radio frequency (RF) access links based on a Uu interface. In examples, the UEs 102 may be simultaneously served by multiple RUS 106 and/or base stations 104, such as the UE 102a of the cell 190a being simultaneously served by access links for the RU 106a of the cell 190a and the base station 104a of the cell 190c.

One or more CUs 110, such as the CU 110a or the CU 110d, may communicate directly with a core network 120 via a backhaul link. For example, the CU 110d may communicate with the core network 120 over a backhaul link based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an A1 link. The SMO framework 116 and/or the non-real time RIC 118 might also communicate with an open cloud (O-cloud) 130 via an O2 link. The one or more CUs 110 may further communicate with each other over a backhaul link based on an Xn interface. For example, the CU 110d of the base station 104a may communicate with the CU 110a of the base station 104b over the backhaul link based on the Xn interface. Similarly, the base station 104a of the cell 190e may communicate with the CU 110a of the base station 104b over a backhaul link based on the Xn interface.

The RUs 106, the DUs 108, and the CUs 110, as well as the near-real time RIC 128, the non-real time RIC 118, and/or the SMO framework 116, may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link between the RU 106d and the baseband unit (BBU) 112 of the cell 190d or, more specifically, the fronthaul link between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104a of the cell 190e via cross-cell communication beams of the RU 106a and the base station 104a.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an E1 interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b may communicate with the UE 102b of the cell 190b via a first set of communication beams 132 of the RU 106b and a second set of communication beams 134 of the UE 102b, which may correspond to inter-cell communication beams or cross-cell communication beams. Both real-time and non-real-time features of control plane and user plane communications of the RUs 106 can be controlled by associated DUs 108. Accordingly, the DUs 108 and the CUs 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RAN coverage, where the dedicated physical resources may be managed through an operations and maintenance interface, such as an O1 interface. For virtualized network elements, the SMO Framework 116 may interact with a cloud computing platform, such as the O-cloud 130 via the O2 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an O1 link to communicate directly with one or more RUs 106. The non-real time RIC 118 of the SMO framework 116 may also be configured to support functionalities of the SMO framework 116. For example, the non-real time RIC 118 may implement logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the A1 interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/ML models for deployment in the near-real time RIC 128. For example, the non-real time RIC 118 may receive the parameters or other information from the O-cloud 130 via the O2 link for deployment of the AI/ML models to the real-time RIC 128 via the A1 link. The near-real time RIC 128 may utilize the parameters and/or other information received from the non-real time RIC 118 or the SMO framework 116 via the A1 link to perform near-real time functionalities. The near-real time RIC 128 and the non-real time RIC 115 may be configured to adjust a performance of the RAN. For example, the non-real time RIC 116 may monitor patterns and long-term trends to increase the performance of the RAN. The non-real time RIC 116 may also deploy AI/ML models for implementing corrective actions through the SMO framework 116, such as initiating a reconfiguration of the O1 link or indicating management procedures for the A1 link.

Any combination of the RU 106, the DU 108, and the CU 110, or reference thereto individually, may correspond to a base station 104. Hence, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e may correspond to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d may utilize antennas of the base station 104a of cell 190d to transmit a downlink/forward link communication to the UE 102d or receive an uplink/reverse link communication from the UE 102d based on the Uu interface associated with the access link between the UE 102d and the base station 104a/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHZ (e.g., 5, 10, 15, 20, 100, 400, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link may utilize a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating bands referred to as frequency range 1 (FR1) and frequency range 2 (FR2). FR1 ranges from 410 MHz-7.125 GHz and FR2 ranges from 24.25 GHZ-52.6 GHz. Although a portion of FR1 is actually greater than 6 GHZ, FR1 is often referred to as the “sub-6 GHZ” band. In contrast, FR2 is often referred to as the “millimeter wave” (mmW) band. FR2 is different from, but a near subset of, the “extremely high frequency” (EHF) band, which ranges from 30 GHZ-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHZ-24.25 GHZ. Frequency bands within FR3 may include characteristics of FR1 and/or FR2. Hence, features of FR1 and/or FR2 may be extended into the mid-band frequencies. Higher operating bands have been identified to extend 5G NR communications above 52.6 GHz associated with the upper limit of FR2. Three of these higher operating bands include FR2-2, which ranges from 52.6 GHZ-71 GHZ, FR4, which ranges from 71 GHZ-114.25 GHZ, and FR5, which ranges from 114.25 GHZ-300 GHz. The upper limit of FR5 corresponds to the upper limit of the EHF band. Thus, unless otherwise specifically stated herein, the term “sub-6 GHZ” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b may transmit a downlink beamformed signal based on a first set of beams 132 to the UE 102b in one or more transmit directions of the RU 106b. The UE 102b may receive the downlink beamformed signal based on a second set of beams 134 from the RU 106b in one or more receive directions of the UE 102b. In a further example, the UE 102b may also transmit an uplink beamformed signal to the RU 106b based on the second set of beams 134 in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104a and a second base station 104b. For instance, the RU 106a of cell 190a may transmit a beamformed signal based on an RU beam set 136 to the base station 104a of cell 190e in one or more transmit directions of the RU 106a. The base station 104a of the cell 190e may receive the beamformed signal from the RU 106a based on a base station beam set 138 in one or more receive directions of the base station 104a. Similarly, the base station 104a of the cell 109e may transmit a beamformed signal to the RU 106a based on the base station beam set 138 in one or more transmit directions of the base station 104a. The RU 106a may receive the beamformed signal from the base station 104a of the cell 190e based on the RU beam set 136 in one or more receive directions of the RU 106a.

The base station 104 may include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a transmit reception point (TRP), a network node, a network entity, network equipment, or other related terminology. The base station 104 or an entity at the base station 104 can be implemented as an IAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104b may be referred to as a next generation-radio access network (NG-RAN).

The core network 120 may include an Access and Mobility Management Function (AMF) 121, a Session Management Function (SMF) 122, a User Plane Function (UPF) 123, a Unified Data Management (UDM) 124, a Gateway Mobile Location Center (GMLC) 125, and/or a Location Management Function (LMF) 126. The core network 120 may also include one or more location servers, which may include the GMLC 125 and the LMF 126, as well as other functional entities. For example, the one or more location servers may include one or more location/positioning servers, which may include the GMLC 125 and the LMF 126 in addition to one or more of a position determination entity (PDE), a serving mobile location center (SMLC), a mobile positioning center (MPC), or the like.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Things (IOT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a mobile client, a client, or other similar terminology. The term UE may also apply to a roadside unit (RSU), which may communicate with other RSU UEs, non-RSU UEs, a base station 104, and/or an entity at a base station 104, such as an RU 106.

Still referring to FIG. 1, in certain aspects, the UE 102 may include a communication gap component 140 configured to activate, based on a beam failure with a serving cell first network entity, a communication gap duration in which the UE refrains from monitoring for signals from the first network entity in at least one of a same component carrier (CC), a first set of CCs of a same band, or a second set of CCs of a band combination associated with the first network entity. The communication gap component 140 is further configured to receive, during the communication gap duration, a candidate beam detection (CBD) reference signal from the neighbor cell second network entity. A measurement of the CBD reference signal fulfilling a criterion may support ICM to one or more candidate beams associated with the second network entity for recovering from the beam failure with the first network entity.

In certain aspects, the base station 104 or an entity of the base station 104 may include an inter-cell mobility (ICM) beam failure recovery (BFR) component 150 configured to transmits, to a UE, a configuration for a communication gap duration. An activation of the communication gap duration is associated with a transmission time of a CBD reference signal from a neighbor cell second network entity and corresponds to a time when the UE does not monitor for signals from the serving cell first network entity in at least one of a same CC, a first set of CCs of a same band, or a second set of CCs of a band combination associated with the first network entity. The ICM BFR component 150 is further configured to communicate with the UE when the communication gap duration expires.

In further aspects, the ICM BFR component 150 is configured to receive a backhaul communication from a serving cell first network entity indicative of a UE configuration for a communication gap duration that corresponds to a time when signals of the first network entity are unmonitored in at least one of a same CC, a first set of CCs of a same band, or a second set of CCs of a band combination associated with the first network entity. An activation of the communication gap duration is associated with a transmission time of a CBD reference signal from the neighbor cell second network entity. The ICM BFR component 150 is further configured to transmit the CBD reference signal based on at least one of the configuration for the communication gap duration or the activation of the communication gap duration. Although the following description may be focused on 5G NR, the concepts described herein may be applicable to other similar areas, such as 5G-Advanced and future versions, LTE, LTE-advanced (LTE-A), and other wireless technologies.

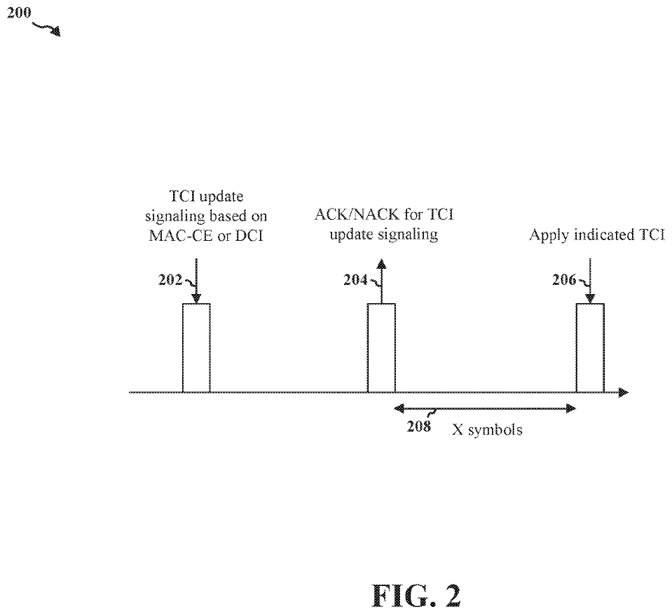

FIG. 2 illustrates a diagram 200 of a transmission configuration indicator (TCI) update procedure based on TCI signaling between a UE and a base station or an entity at a base station. A cell radius/coverage area of the base station might be based on a link budget. The “link budget” refers to an accumulation of total gains and losses in a system, which provide a received signal level at a receiver, such as the UE. The receiver may compare the received signal level to a receiver sensitivity to determine whether a channel provides at least a minimum signal strength for signals communicated between the receiver and a transmitter (e.g., the UE and the base station).

In order to increase the link budget, the base station and the UE might perform an analog beamforming operation to activate a beam pair associated with an increased signal strength. Both the base station and the UE maintain a plurality of beams that may be used for the beam pair. A beam pair that decreases a coupling loss might result in an increased coverage gain for the base station and the UE. “Coupling loss” refers to a path loss/reduction in power density between a first antenna of the base station and a second antenna of the UE, and may be indicated in units of decibel (dB). Beam selection procedures for the beam pair activated by the base station and the UE might be associated with one or more of beam measurement operations, beam measurement reporting, or beam indication procedures.

The base station may indicate 202 a TCI state to the UE via downlink signaling. For example, the base station may indicate 202 TCI updating signaling based on a medium access control-control element (MAC-CE) or downlink control information (DCI). “TCI state” refers to a set of parameters for configuring a quasi co-location (QCL) relationship between one or more downlink reference signals and corresponding antenna ports. For example, the TCI state may be indicative of a QCL relationship between downlink reference signals in a channel state information-reference signal (CSI-RS) set and physical downlink shared channel (PDSCH) demodulation reference signal (DMRS) ports. Due to the theorem of antenna reciprocity, a single TCI state might provide beam indications for both downlink channels/signals and uplink channels/signals.

Beam indication techniques based on TCI signaling may include joint beam indication or separate beam indications. “Joint beam indication” refers to a single/joint TCI state that is used to update the beams for both the downlink channels/signals and the uplink channels/signals. For example, the base station may indicate a single/jointTCIState in downlink TCI signaling that is configured based on a DLorJointTCIState parameter to update the beams for both the downlink channels/signals and the uplink channels/signals. For TCI signaling based on the joint TCI state, the base station may transmit a synchronization signal block (SSB) or a CSI-RS to indicate the QCL relationship between the downlink channels/signals and a spatial relation of the uplink channels/signals. In a first aspect, the transmitted 202 TCI update signaling may correspond to a joint beam indication for both the downlink channels/signals and the uplink channels/signals.

“Separate beam indications” refers to a first TCI state that is used to update a first beam for the downlink channels/signals and a second TCI state that is used to update a second beam for the uplink channels/signals. For example, the base station may indicate the first TCI state in the downlink TCI signaling configured based on the DLorJointTCIState parameter to update the first beam for the downlink channels/signals, and may indicate the second TCI state in further downlink TCI signaling configured based on an UL-TCIState parameter to update the second beam for the uplink channels/signals. If the base station indicates the second TCI state (e.g., uplink TCI) in a downlink reference signal, the downlink reference signal may correspond to the SSB, the CSI-RS, etc. In examples where an uplink reference signal is used to indicate the second TCI state, the uplink reference signal may correspond to a sounding reference signal (SRS), which might indicate the spatial relation of the uplink channels/signals. In a second aspect, the TCI update signaling transmitted 202 may correspond to either the downlink channels/signals or the uplink channels/signals based on the separate beam indications technique.

The base station may configure a QCL type and/or a source reference signal for the QCL signaling. QCL types for downlink reference signals might be based on a higher layer parameter, such a qcl-Type in a QCL-Info parameter. A first QCL type that corresponds to typeA might be associated with a Doppler shift, a Doppler spread, an average delay, and/or a delay spread. A second QCL type that corresponds to typeB might be associated with the Doppler shift and/or the Doppler spread. A third QCL type that corresponds to typeC might be associated with the Doppler shift and/or the average delay. A fourth QCL type that corresponds to typeD might be associated with a spatial receive (Rx) parameter. The UE may use a same spatial transmission filter to indicate the spatial relation as used to receive the downlink reference signal from the base station or transmit the uplink TCI signaling. The transmitted 202 TCI update signaling updates the TCI state for the channels of a CC that share the TCI state indicted based on the TCI update signaling. The CC might be associated with a cell included in a cell list. The cell list is configured based on RRC signaling indicative of parameters such as a simultaneousTCI-UpdateList1 parameter, a simultaneousTCI-UpdateList2 parameter, a simultaneousTCI-UpdateList3 parameter, or a simultaneousTCI-UpdateList4 parameter.

The UE transmits 204 acknowledgment/negative acknowledgment (ACK/NACK) feedback to the base station responsive to the TCI update signaling transmitted 202 from the base station to the UE. The TCI state indicated via the TCI update signaling might be applied 206 by the UE at least X symbols 208 after the UE transmits 204 the ACK/NACK feedback to the base station. For example, if the UE transmits 204 an ACK to the base station in response to the TCI update signaling, the UE applies 206 the indicated TCI state after the configured duration 208. In examples where the UE transmits 204 a NACK to the base station in response to the TCI update signaling, the UE does not apply 206 the TCI state indicated via the TCI update signaling transmitted 202 from the base station to the UE. A duration of the X symbols 208 before the UE applies 206 the indicated TCI state might be configured based on RRC signaling from the base station.

Signaling communicated between the base station and the UE may be dedicated signaling or non-dedicated signaling. “Dedicated signaling” refers to signaling between the base station and the UE that is UE-specific. For example, dedicated signaling may correspond to a physical downlink control channel (PDCCH), a PDSCH, a physical uplink control channel (PUCCH), or a physical uplink shared channel (PUSCH) associated with the cell list that shares the indicated TCI state. “Non-dedicated signaling” refers to signaling between the base station and a non-specific UE. For example, non-dedicated signaling may correspond to a physical broadcast channel (PBCH) or PDCCH/PDSCH transmitted from the base station for non-specific UEs, aperiodic CSI-RS, or SRS for codebook, non-codebook, or antenna switching.

For dedicated signaling from the base station to the UE, the base station transmits 202 the TCI state associated with a first downlink reference signal of a serving cell and/or the TCI state associated with a second downlink reference signal of a neighbor cell/target cell. However, for non-dedicated signaling from the base station to the UE, the base station transmits 202 the TCI state associated with the first downlink reference signal of the serving cell, but not the second downlink reference signal of the neighbor cell/target cell. A lack of TCI state information for non-dedicated signaling from the neighbor cell/target cell might hinder the serving cell from being changed to the neighbor cell/target cell to support ICM procedures.

PDCCH in a control resource set (CORESET) associated with Types 0/0A/OB/1/2 common search spaces, and PDSCH scheduled by such PDCCH are non-dedicated signals. However, other PDCCH and PDSCH signaling may be dedicated signals. For example, periodic/semi-persistent CSI-RS and SRS for beam management may correspond to dedicated signals. The search space type might be defined based on standardized protocols. PUSCH/PUCCH triggered at the UE by the DCI, activated based on the MAC-CE, or configured based on an uplink grant in RRC signaling from the base station are dedicated signals. For rate matching, resource elements (REs) used for channels/signals that the UE 102 does not monitor may correspond to available resources for PDSCH and PDCCH. In an alternative example, the REs used for the channels/signals that the UE 102 does not monitor may correspond to unavailable resources for PDSCH and PDCCH.

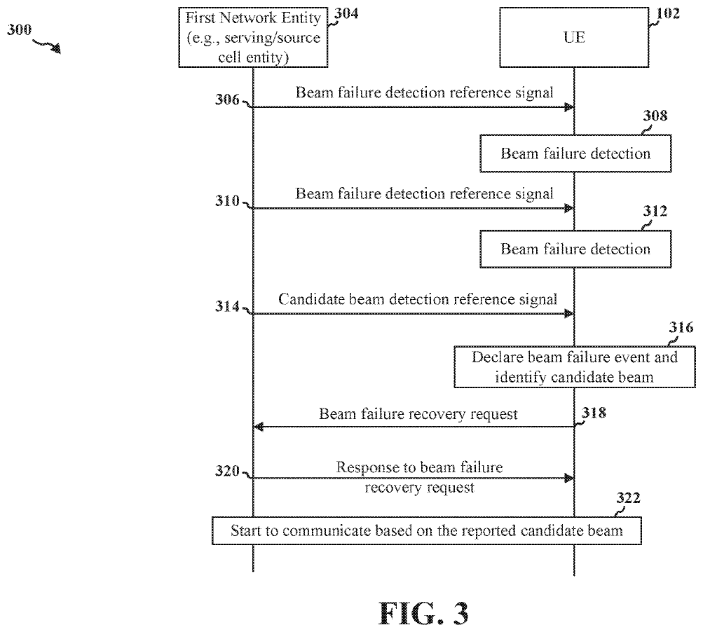

FIG. 3 is a communication signaling diagram 300 illustrating a BFR procedure for a serving cell. For example, a first network entity 304 might correspond to a serving cell base station such as the base station 104 or an entity at the base station 104, such as the RU 106, the DU 108, the CU 110, etc. In one example, the first network entity 304 provides a serving cell to the UE 102 (e.g., RU 106b provides a serving cell 190b to the UE 102b). A beam failure might occur at the UE 102 based on translations, rotations, and/or dynamic blockages to antennas of the UE 102 that might result in an abrupt change to a beam of the UE 102. For example, the UE 102 might experience a beam failure for a control channel beam, such that the UE 102 performs the BFR procedure to recover the control channel beam.

The BFR procedure might be performed by the UE 102 based on one or more beam failure detection (BFD) reference signals, one or more CBD reference signals, a BFR request (BFRQ), and a BFR response (BFRR). The first network entity 304 transmits 306 a first BFD reference signal to the UE 102 for BFD at the UE 102. The UE 102 performs 308 a first instance of BFD based on receiving 306 the BFD reference signal from the first network entity 304. The first network entity 304 may be configured to transmit the BFD reference signal on a periodic basis. Hence, the first network entity 304 might transmit 310 a second BFD reference signal to the UE 102 for BFD at the UE 102. The UE 102 performs 312 a second instance of BFD based on receiving 310 the second BFD reference signal from the first network entity 304.

In examples, the BFD reference signal may correspond to 1-port periodic CSI-RS. The BFD reference signal may be QCLed with DMRS for a PDCCH in a CORESET. At each of the first instance of BFD 308 and the second instance of BFD 312 the UE 102 measures a block error rate (BLER). That is, the UE measures/determines the BLER associated with each of the first BFD reference signal received 306 and the second BFD reference signal received 310. If the measured BLER is above a threshold, the UE 102 associates the BFD instance with a beam failure instance. After identifying N consecutive beam failure instances, the UE 102 declares a beam failure event. The BLER threshold and/or the value of N may be configured to the UE 102 based on RRC signaling (received by the UE 102 prior to the signaling shown in FIG. 3).

The first network entity 304 transmits 314 a CBD reference signal to the UE 102. The UE 102 might monitor for the CBD reference signal on CBD resources configured for the UE 102 based on RRC signaling (received by the UE 102 prior to the signaling shown in FIG. 3). The CBD reference signal may be transmitted by the first network entity 304 on a periodic basis. Hence, the UE 102 might monitor for one or more transmissions of the CBD reference signal from the first network entity 304. The one or more CBD reference signals, such as the CBD reference signal received 314 by the UE 102, might be indicative of a candidate beam for the UE 102 to utilize for communicating with the network. For example, the UE 102 might switch to the candidate beam if a beam failure event is declared by the UE 102.

In the communication signaling diagram 300, the UE 102 declares 316 a beam failure event after identifying N consecutive beam failure instances. The UE 102 may also identify 316 a candidate beam based on the beam failure event, where the UE 102 determines the candidate beam based on one or more CBD reference signals received from the first network entity 304. For example, the UE 102 might receive 314 the CBD reference signal based on the resources configured through the RRC signaling (received by the UE 102 prior to the signaling shown in FIG. 3). A layer 1 (L1) reference signal received power (RSRP) (L1-RSRP) for the candidate beam should be above the threshold configured by the higher layer signaling.

The UE 102 transmits 318 a BFRQ to the first network entity 304. The BFRQ indicates to the first network entity 304 the beam failure event declared 316 by the UE 102. The BFRQ transmitted 318 to the first network entity 304 might also indicate the candidate beam selected by the UE 102 for recovering from the beam failure event. For a PCell or a primary secondary cell (PSCell), the BFRQ may be transmitted 318 to the first network entity 304 on a PRACH. For an SCell, the BFRQ may be transmitted 318 to the first network entity 304 based on a MAC-CE.

The first network entity 304 transmits 320, to the UE 102, a response to the BFRQ in a BFRR message. The response may be indicative of whether the UE 102 can use the indicated candidate beam for recovering from the beam failure event. For a PCell or a PSCell, the UE 102 might receive 320 the BFRR in a DCI. The DCI might be associated with either a dedicated search space (SS) configured based on RRC signaling for contention free random access (CFRA)-based BFR or a message 4 (Msg4) for contention based random access (CBRA)-based BFR. For an SCell, the UE might receive 320 the BFRR in a DCI that schedules a transmission for a same hybrid automatic repeat request (HARQ) process as used for the BFRQ.

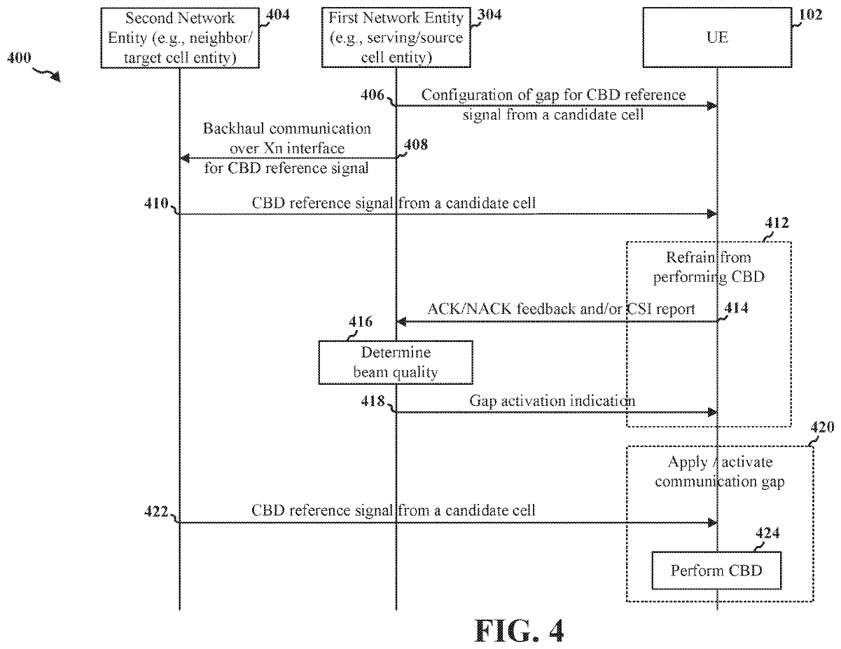

If the response indicates to the UE 102 that the UE 102 can use the BFRQ-indicated candidate beam for recovering from the beam failure event, the UE 102 might start to communicate 322 with the first network entity 304 based on the reported candidate beam. The candidate beam may correspond to one or more channels that share an indicated TCI state. In examples, the UE 102 starts to communicate 322 with the first network entity 304 M symbols (e.g. M=28 symbols) after receiving 320 the BFRR from the first network entity. FIG. 3 supports a BFR procedure for a serving cell. FIG. 4 builds upon FIG. 3 by also supporting a BFR procedure for a neighbor cell/target cell.

FIG. 4 is a communication signaling diagram 400 illustrating a network-activated communication gap at the UE 102. In one example, the first network entity 304 provides a serving cell to the UE 102 (e.g., RU 106b provides a serving cell 190b to the UE 102b) and the second network entity 404 provides a neighbor cell (e.g., RU 106a provides neighbor cell 190a to the UE 102b). In order to support layer 1/layer 2 (L1/L2) ICM, the serving cell first network entity 304 may indicate, to the UE 102, a TCI state associated with a neighbor cell second network entity 404. The second network entity 404 might correspond to the base station 104 or an entity at the base station 104, such as the RU 106, the DU 108, the CU 110, etc. The second network entity 404 may be associated with a neighbor cell/candidate cell that transmits non-dedicated signaling, where the non-dedicated signaling may be received at the UE 102.

The indication of the TCI state to the UE 102 might correspond to a beam indication operation of the first network entity 304. The UE 102 and the first network entity 304 can update the serving cell based on the beam indication operation. In examples, the first network entity 304 might transmit an RRC configuration to the UE 102 based on the second network entity 404 associated with the neighbor/candidate cell. The RRC configuration may be associated with an RRCReconfiguration message indicating RRC parameters for the RRC configuration. After the beam indication operation indicative of the TCI state associated with the second network entity 404, the UE 102 might apply the RRC parameters for the second network entity 404 associated with the candidate cell.

For a BFR procedure based on ICM, the first network entity 304 might indicate a candidate beam for the UE 102 to use for communicating with the second network entity 404 associated with the candidate cell. After the ICM BFR procedure, the UE 102 might update the RRC parameters based on the RRC configuration for the second network entity 404 associated with the candidate cell. Accordingly, the UE 102 may activate/apply the candidate beam associated with the candidate cell for recovering from the beam failure with the first network entity 304 and communicating with the second network entity 404 based on the candidate beam.

The UE 102 might not be able to accurately measure both a CBD reference signal from a candidate cell and a signal from the serving cell in a same CC or different CCs, if the candidate cell and the serving cell are asynchronized or if a propagation delay between the UE 102 and the respective cells differs. Thus, the first network entity 304 indicates when the UE 102 should monitor for CBD reference signals from the second network entity and when the UE 102 should monitor for signals from the first network entity 304. The ICM BFR procedure might also be implemented to avoid frequently switching the serving cell back and forth between two cells (i.e., avoiding a “ping-pong” effect between the first network entity 304 and the second network entity 404). Furthermore, after the UE 102 receives the BFRR, a delay time (e.g., M=28 symbols) to activate/apply the candidate beam for the corresponding channel might be shorter than a time duration for the UE 102 to perform an RRC parameter update, which may result in transmissions from the second network entity 404 occurring before the UE 102 reconfigures to receive signals from the second network entity 404.

While the UE 102 might be able to correct for a certain amount of difference in the propagation delay between the first network entity 304 and the second network entity 404, a signal arrival time difference between the serving cell and the candidate cell that is greater than a cyclic prefix (CP) might cause the UE 102 to be unable to measure the CBD reference signal from the second network entity 404 (e.g., candidate cell) and another signal from the first network entity 304 (e.g., serving cell) in the same CC or different CCs at the same time. Hence, the UE 102 might apply/activate a communication gap duration where the UE refrains from monitoring for signals from the first network entity 304 in order to receive the CBD reference signal from the second network entity 404.

The serving cell first network entity 304 may transmit 406 a configuration to the UE 102 of the communication gap duration, such that the UE 102 may receive a CBD reference signal from the candidate cell (e.g., second network entity 404) during the communication gap duration. The configuration may be transmitted 406 based on higher layer signaling, such as RRC signaling or a MAC-CE. The configuration indicates an activation and/or a deactivation time of the communication gap. The first network entity 304 may configure the communication gap duration per bandwidth part (BWP). The communication gap duration might correspond to X symbols before the CBD reference signal is transmitted from the second network entity 404 and Y symbols after the CBD reference signal is transmitted from the second network entity 404. Values of X and Y may be predefined (e.g. X=Y=1) or configured by the first network entity 304 based on higher layer signaling. The UE 102 does not monitor for signals in the same CC or CCs in a same band or band combination from the first network entity 304 during the communication gap duration. In some examples, the communication gap duration might correspond to the length of the slot that includes the CBD reference signal.

The first network entity 304 transmits 408 a backhaul communication to the second network entity 404 over an Xn interface to indicate the configuration of the communication gap duration at the UE 102. In further examples (not shown), the configuration of the communication gap duration might be based on a backhaul communication from the second network entity 404 to the first network entity 304 indicating periodic transmission times of the CBD reference signal from the second network entity 404. For example, the second network entity 404 might transmit 410 the CBD reference signal from the candidate cell based on a certain periodicity. The UE 102 refrains 412 performing CBD of the CBD reference signal from the candidate cell. That is, the UE 102 does not monitor for or measure the CBD reference signal transmitted 410 from the candidate cell with a physical cell identifier (ID) that is different from the serving cell.

The UE 102 transmits 414 ACK/NACK feedback and/or a channel state information (CSI) report to the first network entity 304 for communications (not shown) between the first network entity 304 and the UE 102. Based on the ACK/NACK feedback and/or the CSI report received 414 the first network entity 304 might determine 416 a beam quality of a beam used for the communications between the first network entity 304 and the UE 102. For example, the first network entity 304 might determine a probability of a beam failure event at the UE 102 based on the ACK/NACK feedback and/or the CSI report. In further examples, the UE 102 may transmit a request to the first network entity 304, such as by MAC CE, for the first network entity 304 to activate the communication gap duration at the UE 102 based on the beam quality determined by the UE 102.

If the first network entity 304 determines 416 that the beam quality is indicative of a beam failure event at the UE 102, the first network entity 304 transmits 418 a gap activation indication to the UE 102. Based on this control signaling, the UE 102 measures the CBD reference signal from the candidate cell during the activated communication gap duration. If the first network entity 304 does not activate the communication gap duration with respect to signaling transmitted from the first network entity 304, the UE does not perform 412 CBD based on the CBD reference signals transmitted from the candidate cell. Alternatively, if the first network entity 304 activates 420 the communication gap, the UE may perform 424 CBD based on one or more CBD reference signals transmitted from the candidate cell. This CBD differs from detection 316 of the serving cell candidate beam shown in FIG. 3.

The UE 102 applies/activates 420 the communication gap duration based on the gap activation indication received 418 from the first network entity and the gap configuration received 406 earlier. During the communication gap duration, the UE 102 may monitor for, receive, and/or measure CBD reference signals from the candidate cell. The UE 102 may perform 424 CBD based on the CBD reference signal received 422 from the second network entity 404. If, based on the CBD, the UE 102 transmits 318 a BFRQ to the first network entity 304 indicating the candidate beam from the neighbor cell second network entity or receives 320 a BFRR from the first network entity 304, the UE 102 and the first network entity 304 may consider the communication gap deactivated. In further examples, the first network entity 304 deactivates the communication gap based on higher layer signaling, such as RRC signaling or MAC-CE.

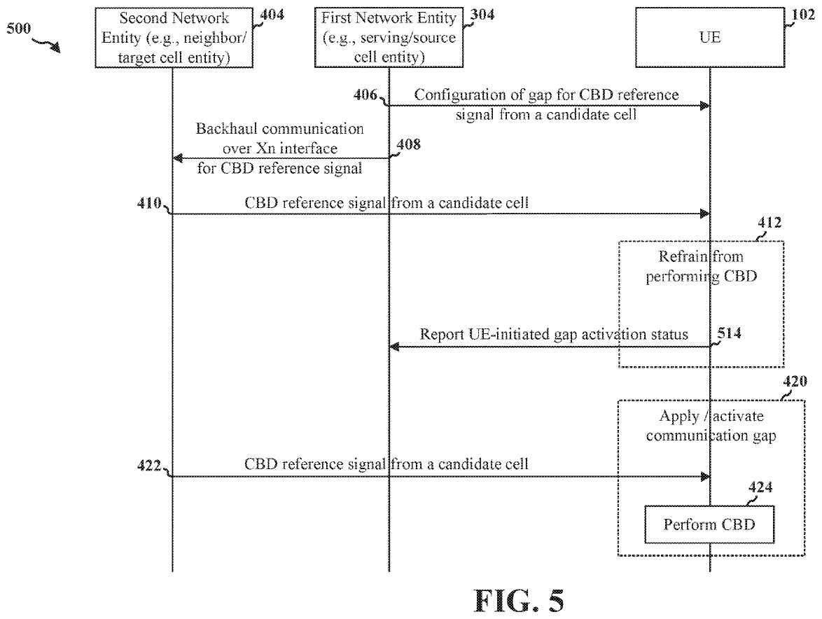

After receiving 406 configuration parameters of a gap to enable monitoring 420 for a CBD reference signal from a candidate cell, either the network or the UE may activate this gap. FIG. 4 shows gap activation by the serving cell first network entity while FIG. 5 shows gap activation by the UE. FIG. 5 is a communication signaling diagram 500 illustrating a UE-activated communication gap at the UE 102.

Elements 406, 408, 410, and 412 of FIG. 5 have already been described with respect to FIG. 4. Instead of the first network entity activating 418 a gap based on serving beam quality, the UE 102 reports 514 to the first network entity 304 a UE-initiated gap activation status (e.g., an indication of one or more times/durations when the communication gap is activated/inactivated at the UE 102). For example, the UE 102 reports 514 that the UE 102 has or intends to activate the communication gap with respect to communications from the first network entity 304 based on a decreased beam quality of a beam used to communicate with the first network entity 304. In further examples, the UE-initiated gap activation status reported to the first network entity 304 indicate a deactivation or termination of the communication gap at the UE 102. If the UE 102 detects a beam failure event, the UE 102 may report to the first network entity 304 an activation of the UE-initiated communication gap. After the UE 102 transmits the report/information to the first network entity, the UE 102 applies/activates 420 the communication gap.

The UE 102 may report 514 the UE-initiated gap activation status to the first network entity 304 on a PRACH or a PUCCH or in a MAC-CE. For example, the UE may transmit the report based on a PRACH resource configured via RRC signaling from the first network entity 304. In further examples, the UE 102 transmits the report based on a dedicated PUCCH resource configured for a scheduling request (SR) for BFR. After the first network entity receives the SR from the UE 102, the first network entity 304 activates a timer for the communication gap duration and refrains from scheduling uplink and downlink communications within the communication gap duration in response to the activation. In still further examples, the UE 102 transmits a MAC-CE or an RRC message (e.g., a gap activation message) to the first network entity 304 to indicate when the UE is activating the communication gap duration. Activation of the communication gap duration may occur over Z slots. That is, the UE 102 may not perform CBD 424 based on the CBD reference signal transmitted 422 from the candidate cell until at least Z slots after the UE 102 reports 514 the status of the UE-initiated gap activation. A value of Z may be predefined (e.g., Z=4) or configured based on higher layer signaling. The UE 102 and first network entity 304 may consider the communication gap deactivated based on a BFRQ or BFRR message or based on higher layer signaling as described with reference to FIG. 4.

When the UE 102 and/or the first/second network entities 304/404 determine that the communication gap duration is activated at the UE 102, the UE attempts to receive a CBD reference signal transmitted 422 from the candidate cell. In other aspects, the UE 102 and the first network entity 304 might determine that the communication gap duration is activated 420 when the UE 102 declares a beam failure event. However, because the first network entity 304 receives no indication (i.e., does not receive 514 a UE-initiated gap activation status report) of when the communication gap duration is enabled at the UE, the first network entity 304 might still schedule downlink communications from the serving cell during the communication gap duration. In such cases, the UE 102 does not monitor for the communications from the first network entity because the gap is activated 420 even though the transmission 514 communicating the gap activation was not received by the first network entity 304.

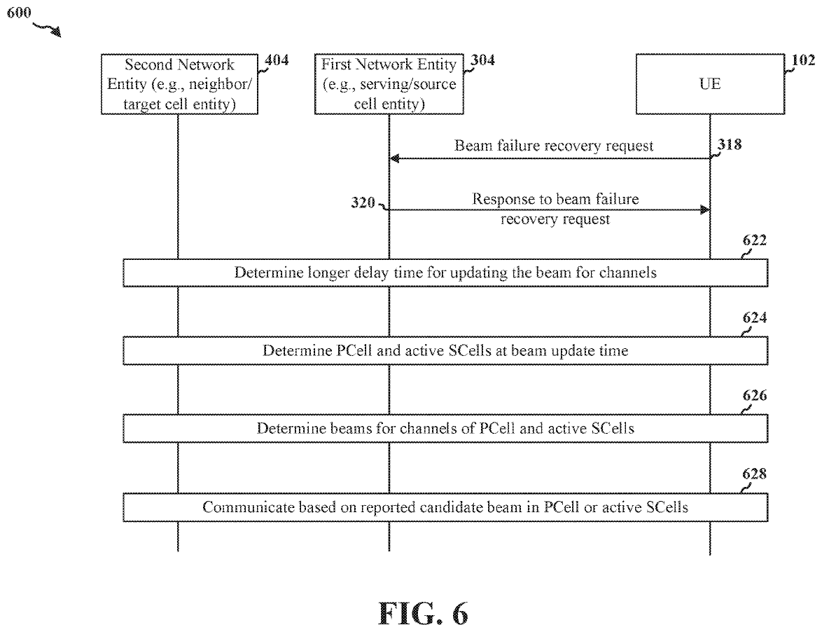

The UE 102 might identify a candidate beam from the CBD reference signal based on one or more conditions. For example, the UE 102 might identify the candidate beam based on the L1-RSRP for the candidate beam received from the candidate cell being above a second threshold or above the first threshold plus an offset, where the first threshold corresponds to the threshold configured for CBD for a beam from the serving cell. The UE 102 might also identify the candidate beam based on the L1-RSRP for a best CBD reference signal from the serving cell being below a third threshold. The UE 102 might also identify the candidate beam based on the L1-RSRP for the candidate beam from the candidate cell being above the L1-RSRP for the best CBD reference signal from the serving cell plus an offset. The thresholds and/or offsets may be predefined or configured based on higher layer signaling, and different conditions may be combined. The L1-RSRP may be substituted in the one or more conditions for identifying the candidate beam from the CBD reference signal with an L1 signal-to-interference plus noise (L1-SINR) or a BLER. FIGS. 4-5 show CBD techniques for selecting a candidate beam, while FIG. 6 shows a BFR procedure based on the candidate beam.

FIG. 6 is a communication signaling diagram 600 illustrating a BFR procedure between the UE 102 and the first/second network entities 304/404. For example, the UE 102 might recover from a beam failure event associated with the serving cell first network entity 304 using on a BFRQ indicating a candidate beam associated with a CBD reference signal from a candidate cell. As described with reference to FIG. 3, the UE 102 transmits 318 a BFRQ to the first network entity 304 and receives 320 a response to the BFRQ (e.g., a BFRR) from the first network entity 304.

If the UE 102 transmits the BFRQ 318 with an indication of a candidate beam associated with a CBD reference signal from a candidate cell, the BFR procedure may correspond to an ICM BFR procedure. Hence, the UE 102 might apply an RRC parameter update for switching channels based on the candidate beam associated with the candidate cell. However, increased complexities associated with ICM procedures may cause the RRC parameter update to occur over a longer duration than a delay time (e.g., M=28 symbols) associated with initiating communications over the candidate beam.

Accordingly, the UE 102 and the first/second network entities 304/404 might determine 622 a second/longer delay time for updating the beam for the channels based on the UE 102 receiving 320 a BFRR associated with the ICM procedure. The second/longer delay time for updating the beam may be predefined or configured based on higher layer signaling, such as RRC signaling. The second/longer delay time may also be indicated based on DCI received from the first network entity 304. Support for this second delay time may be reported as a UE capability in a UE capability report from the UE 102 (not shown). The first network entity may configure the second/longer delay time per candidate cell or as a common delay time across a plurality of candidate cells. In this example, if the candidate beam reported in the BFRQ is associated with one of the plurality of candidate cells, the first network entity 304 and UE 102 both apply the second/longer delay time to update the beam for the channels. Otherwise, the first network entity 304 and UE 102 apply the first/shorter delay time for updating the beam.

The first network entity 304 may explicitly indicate whether the UE 102 should apply the predefined first/shorter delay time or the predefined/configured second/longer delay time in the BFRR transmitted 320 to the UE 102. A 1-bit field may be added in the DCI transmitted from the first network entity 304 to the UE 102 to indicate which delay time the UE 102 is to apply. In further examples, the delay time that the UE 102 is to apply may be indicated based on a starting control channel element (CCE) index for the PDCCH. For example, an odd starting CCE index may indicate that the UE 102 is to apply the first/shorter time delay and an even starting CCE index indicates that the UE 102 is to apply the second/longer time delay.

The UE 102 and the first/second network entities 304/404 might determine 624 the PCell and active SCells at a beam update time. For example, the PCell may correspond to the cell associated with the BFRQ at the beam update time or the cell associated with the BFRR at the beam update time. The first network entity 304 might configure the PCell to UE 102 based on higher layer signaling, such as RRC signaling or MAC-CE, or based on DCI. In other examples, the PCell may correspond to a same cell as a current PCell (i.e., no PCell change).

The first network entity 304 may indicate which cell corresponds to the PCell in the RRC signaling used to provide the configuration of the RRC parameters for the candidate cell. For example, the first network entity 304 may indicate the PCell based on at least a subset of the RRC parameters in an RRCReconfiguration message. The first network entity 304 may also use a field in the DCI associated with the BFRR to indicate which CC corresponds to the PCell. An existing field. such as a serving cell index field, can also be reused to indicate the CC index for the PCell. Similar techniques are also applicable to indications of the PSCell. The first network entity 304 and the UE 102 may determine that cells other than the PCell/PSCell (i.e., SCells associated with the candidate cell) are deactivated at the beam update time. In other examples, the first network entity 304 and the UE 102 may activate at least a subset of cells other than PCell/PSCell at the beam update time. The first network entity 304 may configure one or more active CC indexes to the UE 102 based on higher layer signaling, such as RRC signaling or MAC-CE, or based on DCI.

The UE 102 and the first/second network entities 304/404 might determine 626 beams for channels of the PCell and active SCells. The UE 102 may update the beam for channels that share the indicated TCI state at the beam update time based on the reported candidate beam in BFRQ. The UE 102 may also update the beam for all channels in the PCell/PSCell and/or the active SCells based on the reported candidate beam in the BFRQ. In further examples, the UE 102 may update the beam for PDCCH, PDSCH, PUCCH, or PUSCH in the PCell/PSCell and/or the active SCells based on the reported candidate beam in the BFRQ.

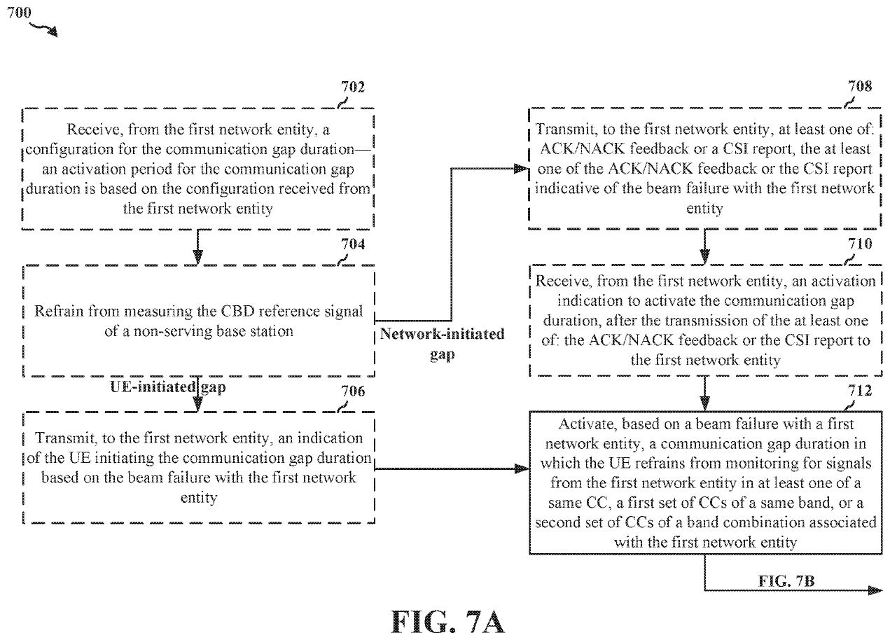

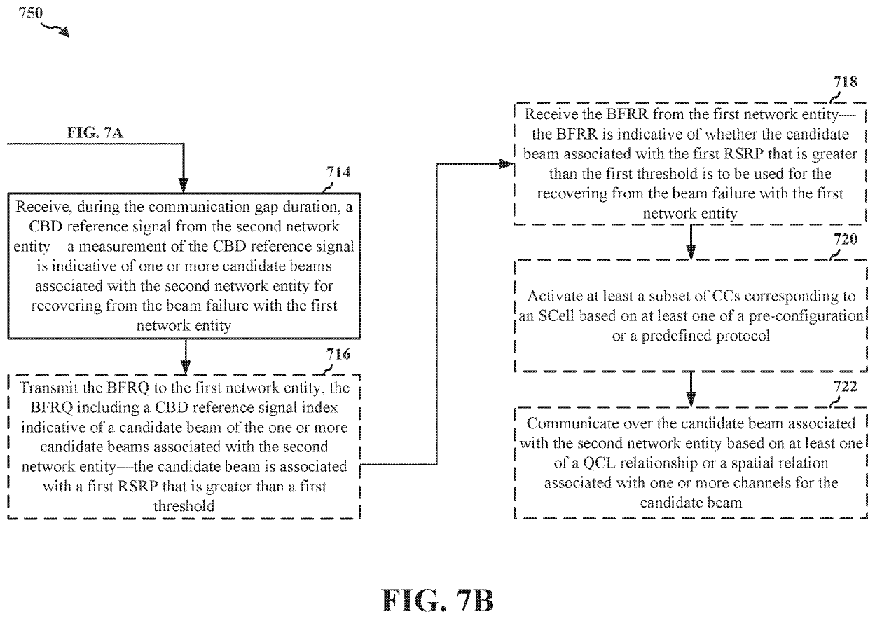

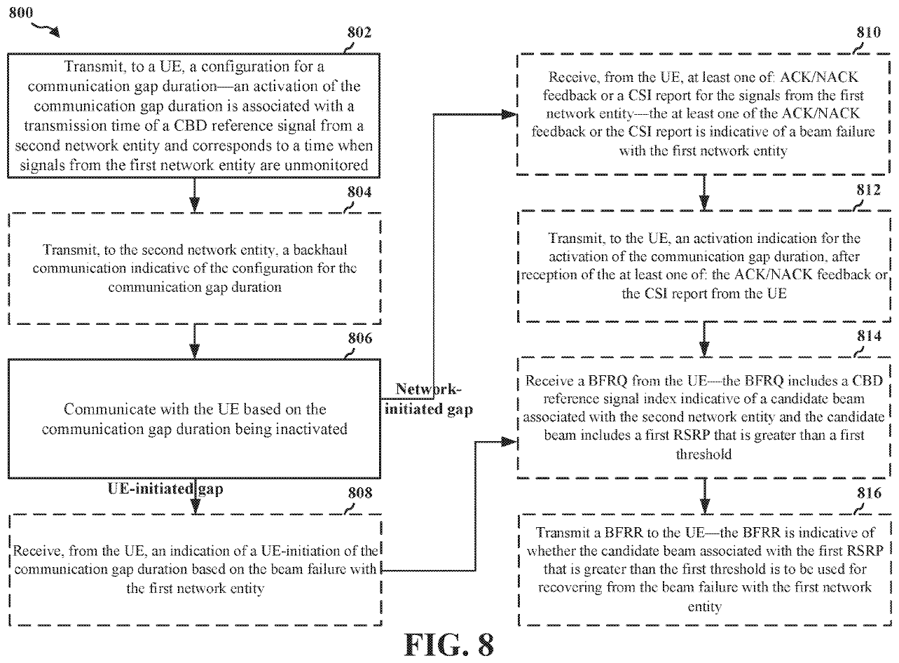

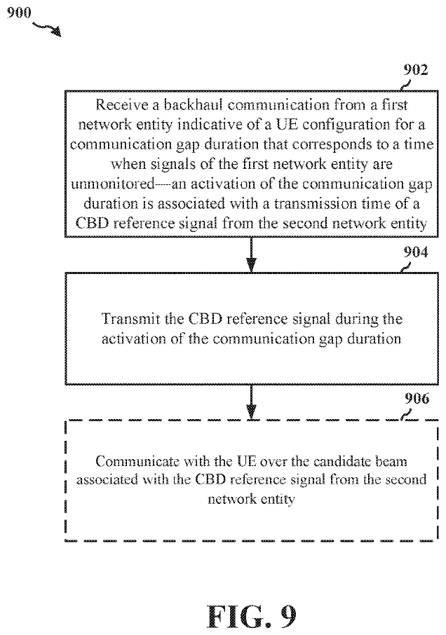

The UE 102 may not monitor at least a subset of the channels/signals in an active cell with a TCI state or a QCL relationship associated with a cell other than the candidate cell. For example, the UE 102 may not monitor the non-dedicated channels/signals in an active CC including a TCI state or a QCL relationship associated with a cell other than the candidate cell. However, the UE 102 may continue to monitor the dedicated channels/signals, even if the TCI state or the QCL relationship is associated with a different cell. The UE 102 may communicate 628 with the first/second network entities 304/404 based on the reported candidate beam in the PCell or the active SCells. FIGS. 4-6 show CBD techniques for selecting a candidate beam to perform an ICM BFR procedure. FIGS. 7A-9 show methods for implementing one or more aspects of FIGS. 4-6. In particular, FIGS. 7A-7B show an implementation by the UE 102 of the one or more aspects of FIGS. 4-6. FIG. 8 shows an implementation by the first network entity 304 of the one or more aspects of FIGS. 4-6. FIG. 9 shows an implementation by the second network entity 404 of the one or more aspects of FIGS. 4-6. Some aspects include the implementation of a UE-initiated communication gap duration, while other aspects include the implementation of a network-initiated communication gap duration.

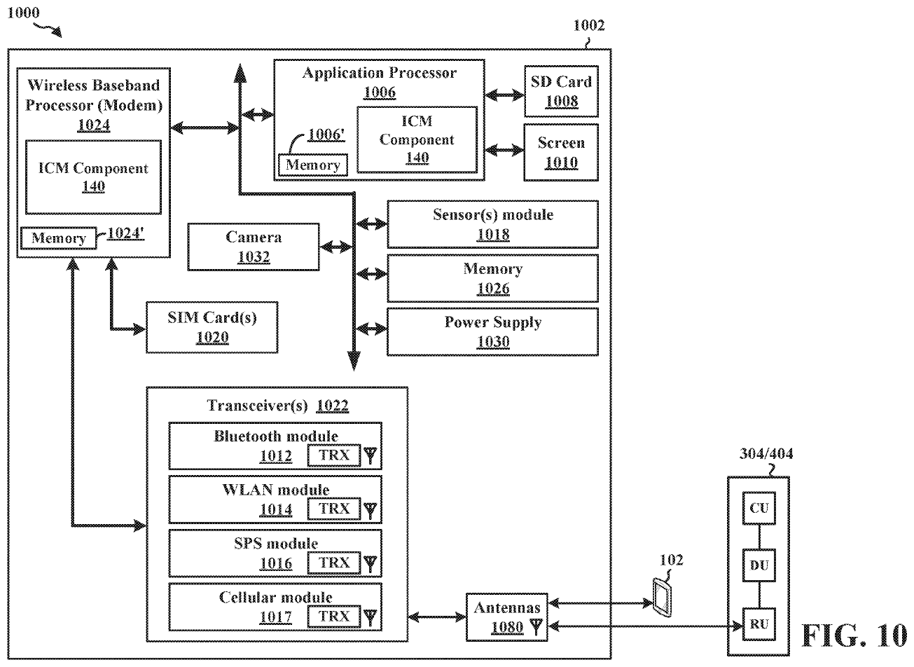

FIGS. 7A-7B illustrate flowcharts 700-750 of a method of wireless communication. With reference to FIGS. 1 and 10, the method may be performed by the UE 102, the apparatus 1002, etc., which may include the memory 1024′ and which may correspond to the entire UE 102 or the apparatus 1002, or a component of the UE 102 or the apparatus 1002, such as the wireless baseband processor 1024, and/or the application processor 1006.

The UE 102 receives 702, from the first network entity, a configuration for the communication gap duration-an activation period for the communication gap duration is based on the configuration received from the first network entity. For example, referring to FIGS. 4-5, the UE 102 receives 406 a configuration of the communication gap duration for the CBD reference signal from the candidate cell (e.g., second network entity 404), such that the communication gap duration may be applied/activated 420 based on the configuration. The communication gap component 140 of the UE 102 or the apparatus 1002 may perform the reception 702.

The UE 102 refrains 704 from measuring the CBD reference signal of a non-serving base station. The UE 102 may, however, measure 308 a BFD reference signal from the serving cell first network entity 304. Similarly, referring to FIGS. 4-5, the UE 102 refrains 412 from performing CBD on the CBD reference signal transmitted 410 from the second network entity 404 based on the CBD reference signal being outside of the communication gap duration applied/activated 420. The communication gap component 140 of the UE 102 or the apparatus 1002 may perform the refraining 704.

A UE or the network entity may activate the communication gap. For a UE-initiated communication gap duration, the UE 102 transmits 706, to the first network entity, an indication of the UE initiating the communication gap duration based on the beam failure with the first network entity. For example, referring to FIG. 5, the UE 102 reports 514 a UE-initiated gap activation status (e.g., an indication of one or more times/durations when the communication gap is activated/inactivated at the UE 102) to the second network entity 404. The communication gap component 140 of the UE 102 or the apparatus 1002 may perform the transmission 706.

For a network-initiated communication gap duration, the UE 102 transmits 708, to the first network entity, at least one of: ACK/NACK feedback or a CSI report, the at least one of the ACK/NACK feedback or the CSI report indicative of the beam failure with the first network entity. For example, referring to FIG. 4, the UE 102 transmits 414 ACK/NACK feedback and/or a CSI report to the first network entity 304 indicative of a beam failure with the first network entity 304. The communication gap component 140 of the UE 102 or the apparatus 1002 may perform the transmission 708.

The UE 102 receives 710, from the first network entity, an activation indication to activate the communication gap duration, after the transmission of the at least one of: the ACK/NACK feedback or the CSI report to the first network entity. For example, referring to FIG. 4, the UE 102 receives 418 a gap activation indication from the first network entity 304 based on the transmission 414 of the ACK/NACK feedback and/or the CSI report to the first network entity 304. The communication gap component 140 of the UE 102 or the apparatus 1002 may perform the reception 710.

The UE 102 activates 712, based on a beam failure with a first network entity, a communication gap duration in which the UE refrains from monitoring for signals from the first network entity in at least one of a same CC, a first set of CCs of a same band, or a second set of CCs of a band combination associated with the first network entity. For example, referring to FIGS. 4-5, the UE 102 applies/activates 420 the communication gap duration for receiving 422 a CBD reference signal from a candidate cell (e.g., second network entity 404). The communication gap component 140 of the UE 102 or the apparatus 1002 may perform the activation 712.

The UE 102 receives 714, during the communication gap duration, a CBD reference signal from the second network entity-a measurement of the CBD reference signal is indicative of one or more candidate beams associated with the second network entity for recovering from the beam failure with the first network entity. For example, referring to FIGS. 4-5, the UE 102 receives 422 the CBD reference signal from a candidate cell (e.g., second network entity 404) during the communication gap duration applied/activated 420 for performing CBD 424. The communication gap component 140 of the UE 102 or the apparatus 1002 may perform the reception 714.

The UE 102 transmits 716 the BFRQ to the first network entity, the BFRQ including a CBD reference signal index indicative of a candidate beam of the one or more candidate beams associated with the second network entity-the candidate beam is associated with a first RSRP that is greater than a first threshold. For example, referring to FIGS. 3 and 6, the UE 102 transmits 318 the BFRQ to the first network entity 304. The communication gap component 140 of the UE 102 or the apparatus 1002 may perform the transmission 716.

The UE 102 receives 718 the BFRR from the first network entity-the BFRR is indicative of whether the candidate beam associated with the first RSRP that is greater than the first threshold is to be used for the recovering from the beam failure with the first network entity. For example, referring to FIGS. 3 and 6, the UE 102 receives 320 a response to the BFRQ (e.g., in a BFRR message) from the first network entity 304. The communication gap component 140 of the UE 102 or the apparatus 1002 may perform the reception 718.

The UE 102 activates 720 at least a subset of CCs corresponding to an SCell based on at least one of a pre-configuration or a predefined protocol. For example, referring to FIG. 6, the UE 102 determines 624 the PCell and the active SCells at a beam update time and determines 626 beams for the channels of the PCell and the active SCells. The communication gap component 140 of the UE 102 or the apparatus 1002 may perform the activation 720.

The UE 102 communicates 722 over the candidate beam associated with the second network entity based on at least one of a QCL relationship or a spatial relation associated with one or more channels for the candidate beam. For example, referring to FIG. 6, the UE 102 communicates 628 based on a reported candidate beam in the PCell or the active SCells. The communication gap component 140 of the UE 102 or the apparatus 1002 may perform the communication 722.

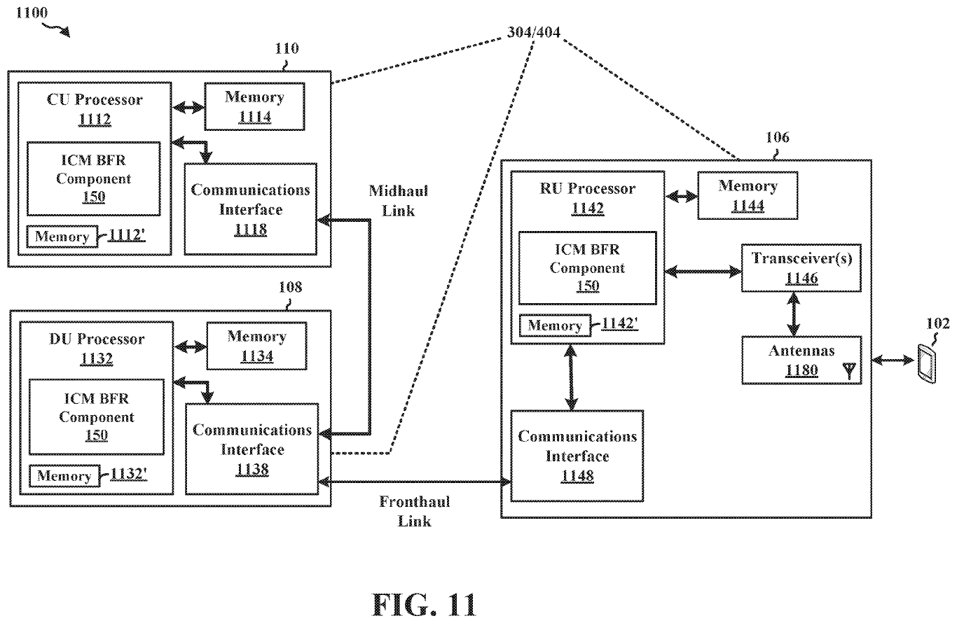

FIG. 8 is a flowchart 800 of a method of wireless communication at a first network entity providing a serving cell. With reference to FIGS. 1 and 11, the method may be performed by the base station 104 or an entity at the base station 104, such as the first network entity 304, which may correspond to the RU 106, the DU 108, the CU 110, the RU processor 1142, the DU processor 1132, or the CU processor 1112, etc. The base station 104 or the entity at the base station 104 may include the memory 1112′/1132′/1142′, which may correspond to the entire first network entity 304 or the base station 104, or a component of the first network entity 304 or the base station 104, such as the RU processor 1142, the DU processor 1132, or the CU processor 1112.

The first network entity 304 or the base station 104 transmits 802, to a UE, a configuration for a communication gap duration-an activation of the communication gap duration is associated with a transmission time of a CBD reference signal from a second network entity and corresponds to a time when signals from the first network entity are unmonitored. For example, referring to FIGS. 4-5, the first network entity 304 transmits 406 a configuration of the communication gap duration to the UE 102 for reception of the CBD reference signal from the candidate cell (e.g., second network entity 404), such that the communication gap duration may be applied/activated 420 based on the configuration. The transmission 802 may be performed by the ICM BFR component 150 of the base station 104 or the first network entity 304 at the base station 104, such as the RU 106, the DU 108, and/or the CU 110.

The first network entity 304 or the base station 104 transmits 804, to the second network entity, a backhaul communication indicative of the configuration for the communication gap duration. For example, referring to FIGS. 4-5, the first network entity 304 transmits 408 a backhaul communication over an Xn interface to the second network entity 404 for transmission of the CBD reference signal based on the configuration 406 of the communication gap duration. The transmission 804 may be performed by the ICM BFR component 150 of the base station 104 or the first network entity 304 at the base station 104, such as the RU 106, the DU 108, and/or the CU 110.

The first network entity 304 or the base station 104 communicates 806 with the UE based on the communication gap duration being inactivated. For example, referring to FIG. 3, the first network entity 304 transmits 306 a first BFD reference signal to the UE 102 and transmits 310 a second BFD reference signal to the UE 102 without the communication gap duration being activated. The communication 806 may be performed by the ICM BFR component 150 of the base station 104 or the first network entity 304 at the base station 104, such as the RU 106, the DU 108, and/or the CU 110.

A UE or the network entity may activate the communication gap. For a UE-initiated communication gap duration, the first network entity 304 or the base station 104 receives 808, from the UE, an indication of a UE-initiation of the communication gap duration based on the beam failure with the first network entity. For example, referring to FIG. 5, the first network entity 304 receives 514 a report indicative of a UE-initiated gap activation status (e.g., an indication of one or more times/durations when the communication gap is activated/inactivated at the UE 102) from the UE 102. The reception 808 may be performed by the ICM BFR component 150 of the base station 104 or the first network entity 304 at the base station 104, such as the RU 106, the DU 108, and/or the CU 110.

For a network-initiated communication gap duration, the first network entity 304 or the base station 104 receives 810, from the UE, at least one of: ACK/NACK feedback or a CSI report for the signals from the first network entity-the at least one of the ACK/NACK feedback or the CSI report is indicative of a beam failure with the first network entity. For example, referring to FIG. 4, the first network entity 304 receives 414 ACK/NACK feedback and/or a CSI report from the UE 102 indicative of a beam failure with the first network entity 304. The reception 810 may be performed by the ICM BFR component 150 of the base station 104 or the first network entity 304 at the base station 104, such as the RU 106, the DU 108, and/or the CU 110.

The first network entity 304 or the base station 104 transmits 812, to the UE, an activation indication for the activation of the communication gap duration, after reception of the at least one of: the ACK/NACK feedback or the CSI report from the UE. For example, referring to FIG. 4, the first network entity 304 transmits 418 a gap activation indication to the UE 102 based on the reception 414 of the ACK/NACK feedback and/or the CSI report from the UE 102 and/or based on the determining 416 of the beam quality between the UE 102 and the first network entity 304 based on the ACK/NACK feedback or the CSI report. The transmission 812 may be performed by the ICM BFR component 150 of the base station 104 or the first network entity 304 at the base station 104, such as the RU 106, the DU 108, and/or the CU 110.

The first network entity 304 or the base station 104 receives 814 a BFRQ from the UE—the BFRQ includes a CBD reference signal index indicative of a candidate beam associated with the second network entity and the candidate beam includes a first RSRP that is greater than a first threshold. For example, referring to FIGS. 3 and 6, the first network entity 304 receives 318 the BFRQ from the UE 102. The reception 814 may be performed by the ICM BFR component 150 of the base station 104 or the first network entity 304 at the base station 104, such as the RU 106, the DU 108, and/or the CU 110.

The first network entity 304 or the base station 104 transmits 816 a BFRR to the UE—the BFRR is indicative of whether the candidate beam associated with the first RSRP that is greater than the first threshold is to be used for recovering from the beam failure with the first network entity. For example, referring to FIGS. 3 and 6, the first network entity 304 transmits 320 a response to the BFRQ (e.g., in a BFRR message) tot the UE 102. The transmission 816 may be performed by the ICM BFR component 150 of the base station 104 or the first network entity 304 at the base station 104, such as the RU 106, the DU 108, and/or the CU 110.

FIG. 9 is a flowchart 900 of a method of wireless communication at a second network entity. With reference to FIGS. 1 and 11, the method may be performed by the base station 104 or an entity at the base station 104, such as the neighbor cell second network entity 404, which may correspond to the RU 106, the DU 108, the CU 110, the RU processor 1142, the DU processor 1132, or the CU processor 1112, etc. The base station 104 or the entity at the base station 104 may include the memory 1112′/1132′/1142′, which may correspond to the entire second network entity 404 or the base station 104, or a component of the second network entity 404 or the base station 104, such as the RU processor 1142, the DU processor 1132, or the CU processor 1112.

The second network entity 404 or the base station 104 receives 902 a backhaul communication from a first network entity indicative of a UE configuration for a communication gap duration that corresponds to a time when signals of the first network entity are unmonitored—an activation of the communication gap duration is associated with a transmission time of a CBD reference signal from the second network entity. For example, referring to FIGS. 4-5, the second network entity 404 receives 408 a backhaul communication over an Xn interface from the first network entity 304 for transmission of the CBD reference signal based on the UE configuration of the communication gap duration transmitted 406 by the first network entity 304. The reception 902 may be performed by the ICM BFR component 150 of the base station 104 or the second network entity 404 at the base station 104, such as the RU 106, the DU 108, and/or the CU 110.

The second network entity 404 or the base station 104 transmits 904 the CBD reference signal during the communication gap duration. For example, referring to FIGS. 4-5, the second network entity 404 transmits 422 the CBD reference signal during the communication gap duration applied/activated 420 based on the configuration of the communication gap duration transmitted 406 by the first network entity 304. The transmission 904 may be performed by the ICM BFR component 150 of the base station 104 or the second network entity 404 at the base station 104, such as the RU 106, the DU 108, and/or the CU 110.

The second network entity 404 or the base station 104 communicates 906 with the UE over the candidate beam associated with the CBD reference signal from the second network entity. For example, referring to FIG. 6, the second network entity 404 communicates 628 with the UE 102 based on the reported candidate beam in the PCell or active SCells. The communication 906 may be performed by the ICM BFR component 150 of the base station 104 or the second network entity 404 at the base station 104, such as the RU 106, the DU 108, and/or the CU 110. A UE apparatus 1002, as described in FIG. 10, may perform the method of flowcharts 700-750, a first network entity 304, such as described in FIG. 11, may perform the method of flowchart 800, and a second network entity 404, such as also described in FIG. 11, may perform the method of flowchart 900.

FIG. 10 is a diagram 1000 illustrating an example of a hardware implementation for a UE apparatus 1002. The apparatus 1002 may be a UE, a component of a UE, or may implement UE functionality. In some aspects, the apparatus 1002 may include a wireless baseband processor 1024 (also referred to as a modem) coupled to one or more transceivers 1022 (e.g., wireless RF transceiver). The wireless baseband processor 1024 may include on-chip memory 1024′. In some aspects, the apparatus 1002 may further include one or more subscriber identity modules (SIM) cards 1020 and an application processor 1006 coupled to a secure digital (SD) card 1008 and a screen 1010. The application processor 1006 may include on-chip memory 1006′.

The apparatus 1002 may further include a Bluetooth module 1012, a WLAN module 1014, an SPS module 1016 (e.g., GNSS module), and a cellular module 1117 within the one or more transceivers 1122. The Bluetooth module 1112, the WLAN module 1114, the SPS module 1116, and the cellular module 1117 may include an on-chip transceiver (TRX) (or in some cases, just a receiver (RX)). The Bluetooth module 1112, the WLAN module 1114, the SPS module 1116, and the cellular module 1117 may include their own dedicated antennas and/or utilize the antennas 1180 for communication. The apparatus 1102 may further include one or more sensor modules 1018 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional modules of memory 1026, a power supply 1030, and/or a camera 1032.

The wireless baseband processor 1024 communicates through the transceiver(s) 1022 via one or more antennas 1080 with another UE 102 and/or with an RU associated with a network entity 304/404. The wireless baseband processor 1024 and the application processor 1006 may each include a computer-readable medium/memory 1024′, 1006′, respectively. The additional modules of memory 1026 may also be considered a computer-readable medium/memory. Each computer-readable medium/memory 1024′, 1006′, 1026 may be non-transitory. The wireless baseband processor 1024 and the application processor 1006 are each responsible for general processing, including the execution of software stored on the computer-readable medium/memory. The software, when executed by the wireless baseband processor 1024/application processor 1006, causes the wireless baseband processor 1024/application processor 1006 to perform the various described functions. The computer-readable medium/memory may also be used for storing data that is manipulated by the wireless baseband processor 1024/application processor 1006 when executing software. The wireless baseband processor 1024/application processor 1006 may be a component of the UE 102. The apparatus 1002 may be a processor chip (modem and/or application) and include just the wireless baseband processor 1024 and/or the application processor 1006, and in another configuration, the apparatus 1002 may be the entire UE 102 and include the additional modules of the apparatus 1002.

As discussed, the communication gap component 140 is configured to activate, based on a beam failure with a first network entity, a communication gap duration in which the UE refrains from monitoring for signals from the first network entity in at least one of a same CC, a first set of CCs of a same band, or a second set of CCs of a band combination associated with the first network entity. The communication gap component 140 is further configured to receive, during the communication gap duration, a CBD reference signal from the second network entity. A measurement of the CBD reference signal is indicative of one or more candidate beams associated with the second network entity for recovering from the beam failure with the first network entity. The communication gap component 140 may be within the wireless baseband processor 1024, the application processor 1006, or both the wireless baseband processor 1024 and the application processor 1006. The communication gap component 140 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1002 may include a variety of components configured for various functions. In one configuration, the apparatus 1002, and in particular the wireless baseband processor 1024 and/or the application processor 1006, includes means for activating, based on a beam failure with a first network entity, a communication gap duration in which the UE refrains from monitoring for signals from the first network entity in at least one of a same CC, a first set of CCs of a same band, or a second set of CCs of a band combination associated with the first network entity; and means for receiving, during the communication gap duration, a CBD reference signal from the second network entity, a measurement of the CBD reference signal indicative of one or more candidate beams associated with the second network entity for recovering from the beam failure with the first network entity. The apparatus 1002 further includes means for receiving, from the first network entity, a configuration for the communication gap duration, where an activation period for the communication gap duration is based on the configuration received from the first network entity. The apparatus 1002 further includes means for refraining from measuring the CBD reference signal outside the communication gap duration. The apparatus 1002 further includes means for transmitting, to the first network entity, at least one of: ACK/NACK feedback or a CSI report, the at least one of the ACK/NACK feedback or the CSI report indicative of the beam failure with the first network entity. The apparatus 1002 further includes means for receiving, from the first network entity, an activation indication to activate the communication gap duration, after the transmitting the at least one of: the ACK/NACK feedback or the CSI report to the first network entity. The apparatus 1002 further includes means for transmitting, to the first network entity, an indication of the UE initiating the communication gap duration based on the beam failure with the first network entity. The apparatus 1002 further includes means for transmitting the BFRQ to the first network entity, the BFRQ including a CBD reference signal index indicative of a candidate beam of the one or more candidate beams associated with the second network entity, the candidate beam associated with a first RSRP that is greater than a first threshold.

In further aspects, the apparatus 1002, and in particular the wireless baseband processor 1024 and/or the application processor 1006, includes means for receiving the BFRR from the first network entity, the BFRR indicative of whether the candidate beam associated with the first RSRP that is greater than the first threshold is to be used for the recovering from the beam failure with the first network entity. The apparatus 1002 further includes means for activating at least a subset of CCs corresponding to an SCell based on at least one of a pre-configuration or a predefined protocol. The apparatus 1002 further includes means for communicating over the candidate beam associated with the second network entity based on at least one of a QCL relationship or a spatial relation associated with one or more channels for the candidate beam. The means may be the communication gap component 140 of the apparatus 1002 configured to perform the functions recited by the means.

FIG. 11 is a diagram 1100 illustrating an example of a hardware implementation for a network entity 304/404. The network entity 304/404 may be a BS, a component of a BS, or may implement BS functionality. The network entity 304/404 may include at least one of a CU 110, a DU 108, or an RU 106. For example, depending on the layer functionality handled by the ICM BFR component 150, the network entity 304/404 can include the CU 110; both the CU 110 and the DU 108; each of the CU 110, the DU 108, and the RU 106; the DU 108; both the DU 108 and the RU 106; or the RU 106.

The CU 110 may include a CU processor 1112. The CU processor 1112 may include on-chip memory 1112′. In some aspects, the CU 110 may further include additional memory modules 1114 and a communications interface 1118. The CU 110 communicates with the DU 108 through a midhaul link, such as an F1 interface. The DU 108 may include a DU processor 1132. The DU processor 1132 may include on-chip memory 1132′. In some aspects, the DU 108 may further include additional memory modules 1134 and a communications interface 1138. The DU 108 communicates with the RU 106 through a fronthaul link. The RU 106 may include an RU processor 1142. The RU processor 1142 may include on-chip memory 1142′. In some aspects, the RU 106 may further include additional memory modules 1144, one or more transceivers 1146, antennas 1180, and a communications interface 1148. The RU 106 communicates wirelessly with the UE 102.

The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various described functions. The computer-readable medium/memory may also be used for storing data that is manipulated by the processor(s) when executing software.

As discussed, the ICM BFR component 150 is configured to transmit, to a UE, a configuration for a communication gap duration. An activation of the communication gap duration is associated with a transmission time of a CBD reference signal from a second network entity and corresponds to a time when signals from the first network entity are unmonitored in at least one of a same CC, a first set of CCs of a same band, or a second set of CCs of a band combination associated with the first network entity. The ICM BFR component 150 is further configured to communicate with the UE based on the communication gap duration being inactivated.

In further aspects, the ICM BFR component 150 is configured to receive a backhaul communication from a first network entity indicative of a UE configuration for a communication gap duration that corresponds to a time when signals of the first network entity are unmonitored in at least one of a same CC, a first set of CCs of a same band, or a second set of CCs of a band combination associated with the first network entity. An activation of the communication gap duration is associated with a transmission time of a CBD reference signal from the second network entity. The ICM BFR component 150 is further configured to transmit the CBD reference signal based on at least one of the configuration for the communication gap duration or the activation of the communication gap duration.

The ICM BFR component 150 may be within one or more processors of one or more of the CU 110, DU 108, and the RU 106. The ICM BFR component 150 may be one or more hardware components specifically configured to carry out the stated processes/algorithm, implemented by one or more processors configured to perform the stated processes/algorithm, stored within a computer-readable medium for implementation by one or more processors, or some combination thereof.

The network entity 304/404 may include a variety of components configured for various functions. In one configuration, the network entity 304/404 includes means for transmitting, to a UE, a configuration for a communication gap duration, an activation of the communication gap duration associated with a transmission time of a CBD reference signal from a second network entity and corresponding to a time when signals from the first network entity are unmonitored in at least one of a same CC, a first set of CCs of a same band, or a second set of CCs of a band combination associated with the first network entity; and means for communicating with the UE based on the communication gap duration being inactivated. The network entity 304/404 further includes means for transmitting, to the second network entity, a backhaul communication indicative of the configuration for the communication gap duration. The network entity 304/404 further includes means for receiving, from the UE, at least one of: ACK/NACK feedback or a CSI report for the signals from the first network entity, the at least one of the ACK/NACK feedback or the CSI report indicative of a beam failure with the first network entity. The network entity 304/404 further includes means for transmitting, to the UE, an activation indication for the activation of the communication gap duration, after the receiving the at least one of: the ACK/NACK feedback or the CSI report from the UE. The network entity 304/404 further includes means for receiving, from the UE, an indication of a UE-initiation of the communication gap duration based on the beam failure with the first network entity. The network entity 304/404 further includes means for receiving a BFRQ from the UE, the BFRQ including a CBD reference signal index indicative of a candidate beam associated with the second network entity, the candidate beam including a first RSRP that is greater than a first threshold. The network entity 304/404 further includes means for transmitting a BFRR to the UE, the BFRR indicative of whether the candidate beam associated with the first RSRP that is greater than the first threshold is to be used for recovering from the beam failure with the first network entity. The means may be the ICM BFR component 150 of the network entity 304/404 configured to perform the functions recited by the means.

In another configuration, the network entity 304/404 includes means for receiving a backhaul communication from a first network entity indicative of a UE configuration for a communication gap duration that corresponds to a time when signals of the first network entity are unmonitored in at least one of a same CC. a first set of CCs of a same band, or a second set of CCs of a band combination associated with the first network entity, an activation of the communication gap duration associated with a transmission time of a CBD reference signal from the second network entity; and means for transmitting the CBD reference signal based on at least one of the configuration for the communication gap duration or the activation of the communication gap duration. The network entity 304/404 further includes means for communicating with the UE over the candidate beam associated with the CBD reference signal from the second network entity. The means may be the ICM BFR component 150 of the network entity 304/404 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Optional blocks of the processes and flowcharts are indicated by dashed lines. The accompanying method claims present elements of the various blocks in an example order, and are not limited to the specific order or hierarchy presented in the claims, processes, and flowcharts.

The detailed description set forth below describes various configurations in connection with the drawings and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, communication signaling diagrams, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A, B, and/or C. such as A and B, A and C, B and C. or A and B and C, and may include multiples of A, multiples of B, and/or multiples of C, or may include A only, B only, or C only. Sets should be interpreted as a set of elements where the elements number one or more.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: activating, based on a beam failure with a first network entity, a communication gap duration in which the UE refrains from monitoring for signals from the first network entity in at least one of a same CC, a first set of CCs of a same band, or a second set of CCs of a band combination associated with the first network entity; and receiving, during the communication gap duration, a CBD reference signal from a second network entity, a measurement of the CBD reference signal indicative of one or more candidate beams associated with the second network entity for recovering from the beam failure with the first network entity.

Example 2 may be combined with example 1 and further includes receiving, from the first network entity, a configuration for the communication gap duration, and includes that an activation period for the communication gap duration is based on the configuration.

Example 3 may be combined with any of examples 1-2 and further includes refraining from measuring the CBD reference signal outside the communication gap duration.

Example 4 may be combined with any of examples 1-3 and further includes transmitting, to the first network entity, at least one of: ACK/NACK feedback or a CSI report, the at least one of the ACK/NACK feedback or the CSI report indicative of the beam failure with the first network entity.

Example 5 may be combined with example 4 and further includes receiving. from the first network entity, an activation indication to activate the communication gap duration, after the transmitting the at least one of: the ACK/NACK feedback or the CSI report to the first network entity.

Example 6 may be combined with any of examples 1-3 and further includes transmitting, to the first network entity, an indication of the UE initiating the communication gap duration based on the beam failure with the first network entity.

Example 7 may be combined with any of examples 1-6 and includes that the communication gap duration is activated a first predetermined number of symbols after at least one of: the receiving the activation indication or the transmitting the indication of the UE initiating the communication gap duration, and includes that the communication gap duration is deactivated a second predetermined number of symbols after the receiving the CBD reference signal from the second network entity.

Example 8 may be combined with any of examples 2-6 and includes that the communication gap duration corresponds to a length of a slot for the receiving the CBD reference signal from the second network entity, and includes that the slot for the receiving the CBD reference signal from the second network entity is indicated based on the configuration for the communication gap duration received from the first network entity.

Example 9 may be combined with any of examples 1-8 and includes that the activating the communication gap duration is based on whether the UE performs at least one of: transmitting a BFRQ indicative of the measurement of the CBD reference signal for the one or more candidate beams or receiving a BFRR indicative of the one or more candidate beams.

Example 10 may be combined with any of examples 1-9 and further includes transmitting the BFRQ to the first network entity, the BFRQ including a CBD reference signal index indicative of a candidate beam of the one or more candidate beams associated with the second network entity, the candidate beam associated with a first RSRP that is greater than a first threshold.

Example 11 may be combined with any of examples 1-10 and further includes receiving the BFRR from the first network entity, the BFRR indicative of whether the candidate beam associated with the first RSRP that is greater than the first threshold is to be used for the recovering from the beam failure with the first network entity.

Example 12 may be combined with any of examples 1-11 and includes that whether the candidate beam is to be used for the recovering from the beam failure with the first network entity is based on at least one of the first RSRP of the candidate beam being above the first threshold, a second RSRP of a serving cell CBD reference signal being below a second threshold, or the first RSRP of the candidate beam being greater than the second RSRP of the serving cell CBD reference signal.

Example 13 may be combined with any of examples 1-12 and includes that a second delay time to switch to the candidate beam associated with the second network entity is longer than a first delay time to switch to an updated serving beam associated with the first network entity.

Example 14 may be combined with any of examples 1-13 and includes that a PCell for communications of the UE after the beam failure corresponds to at least one of a first CC for the transmitting the BFRQ or a second CC for the receiving the BFRR.

Example 15 may be combined with any of examples 1-14 and further includes activating at least a subset of CCs corresponding to an SCell based on at least one of a pre-configuration or a predefined protocol.

Example 16 may be combined with any of examples 1-15 and further includes communicating over the candidate beam associated with the second network entity based on at least one of a QCL relationship or a spatial relation associated with one or more channels for the candidate beam.

Example 17 is a method of wireless communication at a first network entity, including: transmitting, to a UE, a configuration for a communication gap duration, an activation of the communication gap duration associated with a transmission time of a CBD reference signal from a second network entity and corresponding to a time when signals from the first network entity are unmonitored in at least one of a same CC, a first set of CCs of a same band, or a second set of CCs of a band combination associated with the first network entity; and communicating with the UE based on the communication gap duration being inactivated.

Example 18 may be combined with example 17 and further includes transmitting. to the second network entity, a backhaul communication indicative of the configuration for the communication gap duration.

Example 19 may be combined with any of examples 17-18 and further includes receiving, from the UE, at least one of: ACK/NACK feedback or a CSI report for the signals from the first network entity, the at least one of the ACK/NACK feedback or the CSI report indicative of a beam failure with the first network entity.

Example 20 may be combined with examples 19 and further includes transmitting, to the UE, an activation indication for the activation of the communication gap duration, after the receiving the at least one of: the ACK/NACK feedback or the CSI report from the UE.

Example 21 may be combined with any of examples 17-20 and further includes receiving, from the UE, an indication of a UE-initiation of the communication gap duration based on the beam failure with the first network entity.

Example 22 may be combined with any of examples 17-21 and includes that the communication gap duration is at least one of activated or deactivated a number of symbols after at least one of: the transmitting the activation indication or the receiving the indication of the UE-initiation of the communication gap duration.

Example 23 may be combined with any of examples 17-21 and includes that the communication gap duration corresponds to a length of a slot used for the transmission time of the CBD reference signal from the second network entity, and includes that the slot is based on the configuration for the communication gap duration.

Example 24 may be combined with any of examples 17-23 and further includes receiving a BFRQ from the UE, the BFRQ including a CBD reference signal index indicative of a candidate beam associated with the second network entity, the candidate beam including a first RSRP that is greater than a first threshold.

Example 25 may be combined with any of examples 17-24 and further includes transmitting a BFRR to the UE, the BFRR indicative of whether the candidate beam associated with the first RSRP that is greater than the first threshold is to be used for recovering from the beam failure with the first network entity.

Example 26 may be combined with any of examples 17-25 and includes that whether the candidate beam is to be used for the recovering from the beam failure with the first network entity is based on at least one of the first RSRP of the candidate beam being above the first threshold, a second RSRP of a serving cell CBD reference signal from the first network entity being below a second threshold, or the first RSRP of the candidate beam being greater than the second RSRP of the serving cell CBD reference signal.

Example 27 is a method of wireless communication at a second network entity, including: receiving a backhaul communication from a first network entity indicative of a UE configuration for a communication gap duration that corresponds to a time when signals of the first network entity are unmonitored in at least one of a same CC, a first set of CCs of a same band, or a second set of CCs of a band combination associated with the first network entity, an activation of the communication gap duration associated with a transmission time of a CBD reference signal from the second network entity; and transmitting the CBD reference signal based on at least one of the UE configuration for the communication gap duration or the activation of the communication gap duration.

Example 28 may be combined with example 27 and includes that transmissions of the CBD reference signal are unmonitored outside the communication gap duration.

Example 29 may be combined with any of examples 27-28 and includes that the communication gap duration is activated based on the configuration for the communication gap duration, and includes that the communication gap duration is deactivated a number of symbols after the transmitting the CBD reference signal.

Example 30 may be combined with any of examples 27-28 and includes that the communication gap duration corresponds to a length of a slot for the transmitting the CBD reference signal.

Example 31 may be combined with any of examples 27-30 and includes that whether a candidate beam associated with the CBD reference signal is to be used for BFR is based on at least one of a first RSRP of the candidate beam being above a first threshold, a second RSRP of a serving cell CBD reference signal being below a second threshold, or the first RSRP of the candidate beam being greater than the second RSRP of the serving cell CBD reference signal.

Example 32 may be combined with any of examples 27-31 and includes that a second delay time associated with a candidate beam activation is longer than a first delay time associated with a serving beam activation.

Example 33 may be combined with any of examples 27-32 and includes that at least a subset of CCs corresponding to an SCell is activated based on at least one of a pre-configuration or a predefined protocol.

Example 34 may be combined with any of examples 27-33 and further includes communicating with the UE over the candidate beam associated with the CBD reference signal from the second network entity.

Example 35 is an apparatus for wireless communication for implementing a method as in any of examples 1-34.

Example 36 is an apparatus for wireless communication including means for implementing a method as in any of examples 1-34.

Example 37 is a non-transitory computer-readable medium storing computer executable code, the code when executed by at least one processor causes the at least one processor to implement a method as in any of examples 1-34.

1. A method of wireless communication at a user equipment (UE), comprising:
performing at least one of:
activating a communication gap duration in which the UE refrains from monitoring for signals from a first network entity in order to receive
a candidate beam detection (CBD) reference signal from a second network entity; or
deactivating the communication gap duration in which the UE monitors for signals from the first network entity; and
communicating with the first network entity or the second network entity based on the performing the at least one of the activating the communication gap duration or the deactivating the communication gap duration.

2. The method of claim 1, further comprising receiving, from the first network entity, a configuration for the communication gap duration, wherein an activation period or deactivation period for the communication gap duration is based on the configuration.

3. The method of claim 1, further comprising refraining from measuring a candidate beam detection (CBD) reference signal when the communication gap duration is deactivated.

4. The method of claim 1, further comprising transmitting, to the first network entity, at least one of: acknowledgment/negative acknowledgement (ACK/NACK) feedback or a channel state information (CSI) report, the at least one of the ACK/NACK feedback or the CSI report indicates a beam failure with the first network entity; and
receiving, from the first network entity, an activation indication to activate the communication gap duration, after the transmitting the at least one of the ACK/NACK feedback or the CSI report to the first network entity.

5. The method of claim 1, wherein the UE performs the activating the communication gap duration, further comprising receiving. during the communication gap duration. the CBD reference signal from the second network entity, a measurement of the CBD reference signal indicates one or more candidate beams associated with the second network entity for recovering from a beam failure with the first network entity.

6. The method of claim 1, further comprising transmitting, to the first network entity, an indication of the UE initiating the communication gap duration based on a beam failure with the first network entity.

7. The method of claim 1, wherein the communication gap duration is activated a first predetermined number of symbols after at least one of: reception of an activation indication or transmission of an indication of the UE initiating the communication gap duration, and wherein the communication gap duration is deactivated a second predetermined number of symbols after reception of the CBD reference signal from the second network entity.

8. The method of claim 2, wherein the communication gap duration corresponds to a length of a slot for reception of the CBD reference signal from the second network entity, and wherein the slot for the reception of the CBD reference signal from the second network entity is indicated based on the configuration for the communication gap duration received from the first network entity.

9. The method of claim 1, further comprising transmitting a beam failure recover request (BFRQ) to the first network entity, the BFRQ including the CBD reference signal index that indicates a candidate beam of one or more candidate beams associated with the second network entity, the candidate beam associated with a first reference signal received power (RSRP) that is greater than a first threshold.

10. The method of claim 9, further comprising receiving a beam failure recovery response (BFRR) from the first network entity, the BFRR indicates that the candidate beam associated with the first RSRP that is greater than the first threshold is to be used for the recovering from the beam failure with the first network entity.

11. The method of claim 9, wherein a second delay time to switch to the candidate beam associated with the second network entity is longer than a first delay time to switch to an updated serving beam associated with the first network entity.

12. The method of any of claim 10, wherein a primary cell (PCell) for communications of the UE after the beam failure corresponds to at least one of a first CC for transmission of the BFRQ or a second CC for reception of the BFRR.

13. The method of claim 1, further comprising activating at least a subset of CCs corresponding to a secondary cell (SCell) based on at least one of a pre-configuration or a predefined protocol.

14. The method of claim 1, further comprising communicating over a candidate beam associated with the second network entity based on at least one of a quasi co-location (QCL) relationship or a spatial relation associated with one or more channels for the candidate beam.

15. A method of wireless communication at a first network entity, comprising:
transmitting, to a user equipment (UE), a configuration for at least one of:
activating a communication gap duration in which the UE refrains from monitoring for signals from the first network entity in order to receive a candidate beam detection (CBD) reference signal from a second network entity; or
deactivating the communication gap duration in which the UE monitors for signals from the first network entity; and
communicating with the UE based on the configuration.

16. The method of claim 15, further comprising:
receiving, from the UE, at least one of: acknowledgement/negative acknowledgement (ACK/NACK) feedback or a channel state information (CSI) report for the signals from the first network entity, the at least one of the ACK/NACK feedback or the CSI report indicates a beam quality associated with the first network entity: and
transmitting, to the UE based on the beam quality associated with the first network entity, an activation indication for the activation of the communication gap duration.

17. The method of claim 15, further comprising receiving, from the UE, an indication of a UE-initiation of the communication gap duration based on a beam quality associated with the first network entity.

18. The method of claim 17. wherein the
communication gap duration is activated a first predetermined number of symbols after at least one of: transmission of
indication for the activation of the communication gap duration or reception of the indication of the UE-initiation of the communication gap duration.

19. An apparatus for wireless communication at a user equipment (UE). comprising:
a transceiver:
a memory; and
a processor coupled to the memory and the transceiver, the processor configured to:
perform at least one of:
activate a communication gap duration in which the UE refrains from monitoring for signals from a first network entity in order to receive a candidate beam detection (CBD) reference signal from a second network entity; or
deactivate the communication gap duration in which the UE monitors for signals from the first network entity; and
communicate with the first network entity or the second network entity based on the performing the at least one of the activating the communication gap duration or the deactivating the communication gap duration.

20. The apparatus of claim 19, wherein the processor is configured to:
refrain from measuring a candidate beam detection (CBD) reference signal when the communication gap duration is deactivated.
